(19) United States
(12) Patent Application Publication
(10) Pub. No.: US 2022/0055146 A1
(43) Pub. Date: Feb. 24, 2022

(54) METHOD OF PROCESSING AN OBJECT WITH A LIGHT BEAM, AND PROCESSING SYSTEM

(71) Applicant: ETXE-TAR, S.A., Elgoibar (ES)

(72) Inventor: Jose Juan GABILONDO, Elgoibar (ES)

(21) Appl. No.: 17/312,728

(22) PCT Filed: Dec. 16, 2019
(86) PCT No.: PCT/EP2019/085458

§ 371 Date: Jun. 10, 2021

(30) Foreign Application Priority Data
Dec. 20, 2018 (EP) 18382960.5

(51) Int. Cl. B23K 26/03; B23K 31/12

(52) U.S. Cl. CPC B23K 26/032; B23K 26/082; B23K 31/125; B23K 26/034

(57) ABSTRACT

A method of processing an object with a light beam includes the following steps:
projecting a light beam onto the object via a first scanner so as to produce a heated area by locally heating the object;
displacing the heated area along a track on the object;
capturing images of a first portion of the object with a first camera, via the first scanner; and
capturing images of a second portion of the object with a second camera, via a second scanner.

The first scanner and the second scanner are operated so that the first camera captures images of the heated area, whereas the second camera captures images of portions of the object behind and/or ahead of the heated area.

### TECHNICAL FIELD

The present disclosure relates to the field of processing one or more workpieces using a light beam, such as a laser beam. More specifically, the disclosure relates to camera based process control.

### BACKGROUND

The use of light beams, especially laser beams, for processing workpieces has increased rapidly during the last decades, and sophisticated systems have been developed for tasks such as laser welding, laser cladding, additive manufacturing, laser hardening, etc. Also, there has been an increase in the use of machine vision, that is, in the use of some kind of cameras, for monitoring and controlling the processes, including tasks such as quality control.

For example, in the context of laser welding and additive manufacturing, cameras are known to be used to monitor the melt pool, for example, to monitor its position and extension as well as temperatures. Cameras are also known to be used to monitor the cooling rate, which is known to have an impact on the microstructural evolution in the context of, for example, additive manufacturing. Thus, for example, one or more cameras can be used to establish a thermal map of the melt pool and its surroundings. Reference is made to the thesis “Control of the Microstructure in Laser Additive Manufacturing” by Mohammad Hossein Farshidianfar, presented to the University of Waterloo, Ontario, Canada, discussing closed-loop control of microstructural aspects of laser additive manufacturing products. That document includes a discussion of a closed-loop system based on an infrared camera used to detect melt pool temperature and cooling rate. Another example of laser process control using machine vision is the communication “OCT Technology Allows More than Laser Keyhole Depth Monitoring” disclosed in Laser Technik Journal 5/2015 (Wiley-VCH Verlag GmbH&Co. KGaA, Weinheim), pages 18-19, discussing the use optical coherence tomography (OCT) using an OCT scanner connected to a laser processing head through a camera port, in the context of laser processing applications with emphasis on laser welding.

Different camera configurations are known in the art, as discussed in for example Z. Echegoyen et al., “A Machine Vision System for Laser Welding of Polymers”, Proceedings of the 30th International Manufacturing Conference, pages 239-247. Here, two different set-ups are discussed, one with an external camera configuration and one with a coaxial camera configuration, schematically illustrated in FIGS. 1A and 1B, respectively.

FIG. 1A illustrates a prior art arrangement in which a laser processing head 2000 including a mirror 12, a scanner 13 (such as a galvanometric scanner with galvanometric mirrors) and a F-theta lens 14 for directing a laser beam 11A from a laser source 11 onto an object 1000. The scanner 13 can operate following instructions from a control system (not illustrated) so as to displace the laser beam over the object (for example, over a layer of material to be selectively solidified in an additive manufacturing process, over an interface area between two or more workpieces to be joined by laser welding, etc.) in a controlled manner.

A camera 2002 is provided externally to the laser processing head, for taking images of the entire object 1000 or, at least, of the entire area subjected to processing. Thus, one single camera shot can provide information about the entire processing area, and as there are generally no element between the camera (including its lens system) and the object, the quality of the images can be very high. However, due to the large area that is imaged, the resolution is relatively low. This can require the use of a camera with high resolution, which can be relatively costly.

FIG. 1B shows a similar laser processing head 2001 including mirror 12, scanner 13 and F-theta lens 14, for directing a laser beam 11A from a laser source 11 onto an object 1000. However, here, a so-called co-axial arrangement of the camera 2003 is used, so that the camera views the workpiece coaxially with the laser beam, and receives light from the laser beam via a path including the F-theta lens 14, the scanner 13 and the mirror 12, which in this case is a dichroic mirror or beam-splitter, highly reflective for the wavelength corresponding to laser light but highly transparent for other wavelengths, including the wavelengths—such as those corresponding to the infrared part of the spectrum—intended to be detected by the camera 2003.

The field of view of the coaxially arranged camera 2003 is much smaller than the one of the externally arranged camera 2002, thereby allowing for higher resolution and/or for the use of a camera with less resolution. However, the images captured can be less clear, due to the larger number of elements in the path between the object 1000 and the camera 2003. For example, the F-theta lens 14 can give rise to lateral chromatic aberrations. Also, the arrangement may be impractical if the camera is to be used for detecting certain wavelengths, such as wavelengths for which the mirror is highly or moderately reflective.

A further problem in the context of thermal imaging and especially in the context of quality control and non-destructive testing is the fact that cameras often feature a trade-off between resolution and frame rate, whereas there is often a desire both for high spatial resolution of the images and for high frame rates. This can especially be so in contexts where not only the general shape and temperatures of the melt-pool are to be observed, but where additional information about the process, such as about cooling rates etc., is needed.

US-2015/0083697-A1 discloses a method and device for laser processing, in particular laser welding, including two scanner devices and associated image capturing units. At least one of the scanner devices is used for directing a laser beam onto a workpiece. The second scanner device and associated image capturing unit may be used for preliminary edge recognition.

WO-2018/129009-A1 discloses an additive manufacturing system. In one embodiment, a laser beam is directed across a build plate using a scanning device, which is also associated to an optical detector for detecting positions of fiducial marks for alignment. Another scanning device is used for directing electromagnetic radiation generated by a melt pool to another optical detector.

### SUMMARY

A first aspect of the disclosure relates to a method of processing an object with a light beam, comprising the steps of:

projecting a light beam, such as a laser beam, onto an object via a first scanner for processing the object, said light beam projecting a light spot on the object for producing a heated area, such as a melt pool, an area heated to an austenitization temperature for hardening, etc., by locally heating the object;

displacing the heated area along a track on the object, for example, using the first scanner and/or other means forming part of the equipment, such as by moving a processing head including the first scanner in relation to the object, or vice-versa, or both;

capturing images of a first portion of the object with a first camera, via the first scanner;

capturing images of a second portion of the object with a second camera, via a second scanner;

wherein the method comprises operating the first scanner and the second scanner so that the first camera captures images of the heated area, whereas the second camera captures images of portions of the object trailing behind the heated area and/or ahead of the heated area.

Thus, and whereas the first camera can be used to monitor the heated area, such as a melt pool, or a part thereof, and features thereof such as its size, shape, maximum temperature and/or temperature distribution, the second camera can be used to monitor the temperature or temperature profile ahead of the heated area or behind it (such as ahead or behind a melt pool), that is, in the area where for example cooling and solidification are taking place, or the area to be heated. Thus, the second camera can be used to determine, for example, the cooling rate, a parameter that can often be useful for quality control due to its influence on the microstructure of the object after processing. The method makes it possible to obtain information about how the heating and the subsequent cooling of the object take place along the track, with high resolution in space and time and using relative simple equipment. The method also makes it possible to obtain information about the status of the area that is to be heated, so that the heating can be carried out in an optimum manner, taking into account, for example, the shape of the track to be followed by the laser spot, the temperature thereof, irregularities, holes, etc. Information from a camera that is imaging the area ahead of the heated area can, for example, be used to influence the manner in which the first scanner is operated, for example, to make the laser spot correctly follow the track and/or to correctly configure the two-dimensional energy distribution of an effective spot generated by two-dimensional scanning of laser beam using the first scanner, this two-dimensional scanning being overlaid on the basic movement of the heated area along the track.

In some embodiments, one or both of the first and second scanners are galvanometric scanners including one or more scanning mirrors or similar, through which the cameras can obtain their respective images.

In some embodiments, the method further comprises the step of repetitively scanning the light beam in two dimensions with the first scanner so that the light beam follows a two-dimensional scanning pattern and establishes an effective spot having a two-dimensional energy distribution determined by at least the scanning pattern followed by the light beam, a scanning speed and a light beam power, and wherein the two-dimensional energy distribution is dynamically adapted while the heated area is displaced along the track. Any suitable parameter can be used to dynamically adapt the two-dimensional energy distribution. For example, the scanning pattern and/or the velocity of the laser beam along the scanning pattern or portions thereof can be adapted. In some embodiments the beam power is kept constant or substantially constant. The dynamic adaptation can in some embodiments be carried out based on information obtained by the second camera, for example, based on information obtained about the status of the object ahead of the heated area or behind the heated area. Information about the object ahead of the heated area can also be used to influence the first scanner and/or the means displacing the processing head, for example, to make sure that the heated area correctly follows an interface area between two workpieces or parts of a workpiece when carrying out laser welding.

The effective spot can be created and adapted using, for example, techniques such as those described in WO-2014/037281-A2 or WO-2015/135715-A1, which are incorporated herein by reference. Whereas the descriptions of these publications are primarily focused on the laser hardening of journals of crankshafts, it has been found that the principles disclosed therein regarding the scanning of the laser beam can be applied also to other technical fields, including laser welding, additive manufacturing, or heat treatment of sheet metal.

Typically, when using an effective spot created by relatively rapid two-dimensional scanning of a light beam along a scanning pattern, the velocity of the light beam (where projected onto the workpiece) along the scanning pattern is substantially higher than the velocity of the effective spot along the track, such as at least 5, 10, 50 or 100 times higher.

In some embodiments of the disclosure, the first scanner is used to displace the heated area along the track and the first scanner and the second scanner are operated in synchronization so that the second camera captures images of the object having a pre-determined spatial and/or temporal relation to the heated area. For example, when the first scanner is used to displace the heated area long the track, the second scanner can be used to displace the portions of which images are being captured with the second camera, such that these portions bear a predetermined spatial and/or temporal relationship with the heated area, such as ahead of it or behind it, with a selected spacing in terms of distance and/or time. In some embodiments of the disclosure, the method further comprises the step of repetitively scanning in two dimensions with the second scanner and operating the second camera in synchronization with the second scanner so as to repetitively obtain a sequence of images of different subareas of the object behind and/or ahead of the heated area. In some of these embodiments, the different subareas are arranged adjacent to each other. It can sometimes be preferred that an image with high resolution be obtained of a relatively large area. Sometimes the need of coverage and spatial resolution is higher than what is possible to achieve with one single camera (such as a thermal camera), at least at a reasonable cost and using commercially available equipment. However, it has been found that there are scanners that operate with a reliability and velocity that is compatible with obtaining pictures of a sequence of subareas, such as of a sequence of adjacent subareas together forming a larger area, at a relatively high frequency, so that these individual image frames corresponding to different subareas can provide useful information about the over-all state of the total area made up of these subareas. That is, for example, four M×N pixel images of four corresponding adjacent subareas can in principle be combined to provide a full 2M×2N image of a larger area or portion of the object. That is, 2M×2N resolution images of the area trailing behind the heated area can be obtained, while using one single camera with M×N pixel capacity. Thus, the second scanner can be used not (or not only) to make the second camera follow the heated area (that is, to make the focus of the camera, or the area from which thermal radiation is received by the second camera, follow the heated area), but can be (additionally) used to increase the resolution of the image in relation to the surface of the total area that is imaged by the second camera. The velocity of the scanning in two dimensions is preferably much higher than any velocity with which the second scanner tracks the heated area (for example, by tracking the first scanner) in order to make the second camera follow the melt pool or lead ahead of the melt pool. That is, the second scanner can be operated by a control function including one relatively rapid component of two-dimensional scanning for obtaining the sequences of images of the different subareas, and optionally a further, relatively slow, component corresponding to the co-ordination with the movement of the heated area, that is, the second component ensures that the subareas of which images are taken maintain a certain relation to the heated area while the heated area is being displaced due to scanning performed by the first scanner and, optionally, due to a relative movement between the scanners and the object, such as due to movement between a laser processing head and the object. In other embodiments, movement of the heated area is due to the relative movement between the laser processing head and the object, whereas the first scanner is used to establish the effective spot by repetitive two-dimensional scanning of the laser beam, whereas the second scanner is used for obtain the sequence of images of the different subareas.

In some embodiments, the subareas are arranged in rows and columns forming a matrix. That is, the two-dimensional scanning by the second scanner can be used to obtain a series of images that together from a larger composite image composed of the individual images, arranged in rows and columns.

In some embodiments of the disclosure, the cameras are infrared cameras. In some embodiments, one or both of the cameras are thermal imaging cameras such as IR cameras. IR cameras are suitable for thermal imaging and commercially available cameras provide reasonably high resolution and frame rate and a reasonable cost. In other embodiments, at least one of the cameras, such as the second camera, is a camera adapted for wavelengths in the visual spectrum, including at least 100%, 90%, 80%, 70%, 60% or 50% of the range from 380 to 750 nanometers.

In some embodiments of the disclosure, both the first scanner (13) and the second scanner are arranged in a processing head, that is, in one and the same processing head, optionally displaceable in relation to the object. The first and the second cameras are preferably also arranged in or attached to said processing head. This provides for a compact arrangement.

In some embodiments, the method is a method for additive manufacturing.

In some embodiments, the method is a method for joining at least two workpieces by welding them together.

In some embodiments, the method is a method for laser cladding.

In some embodiments, the method is a method for laser hardening.

In some embodiments, the light beam is a laser beam.

The method can, for example, be a method for laser welding, laser cladding, or additive manufacturing. The object can be any suitable object, for example, a layer of powder to be solidified, two or more workpieces to be welded together in correspondence with an interface area, etc.

A further aspect of the disclosure is a processing system comprising a processing head for projecting a light beam onto an object for processing the object, the processing head including a first scanner for controlled displacement of the light beam in relation to the object, the system further comprising a first camera associated to the first scanner for capturing images of a portion of the object via the first scanner, the system further comprising a second camera and a second scanner, the second camera being associated to the second scanner for capturing images of a portion of the object via the second scanner, the system being programmed for operating the first scanner and the second scanner so that during processing of the object with the light beam, the first camera captures images of a heated area produced by the light beam, whereas the second camera captures images of portions ahead of the heated area and/or trailing behind the heated area.

In some embodiments, the processing head includes the first scanner, the second scanner, the first camera and the second camera.

In some embodiments, the processing system is programmed for operating according to the method described above.

### BRIEF DESCRIPTION OF THE DRAWINGS

To complete the description and in order to provide for a better understanding of the disclosure, a set of drawings is provided. Said drawings form an integral part of the description and illustrate an embodiment of the disclosure, which should not be interpreted as restricting the scope of the disclosure, but just as an example of how the disclosure can be carried out. The drawings comprise the following figures:

FIGS. 1A and 1B are schematic side elevation views of prior art camera arrangements in relation to a laser processing head;

FIG. 2 is a schematic side elevation view of a laser processing system in accordance with an embodiment of the disclosure; and

FIGS. 3-5 are schematic top views of an object subjected to laser processing, schematically indicating the relation between images captured by the first and second cameras in accordance with three alternative embodiments of the disclosure.

### DETAILED DESCRIPTION OF THE DRAWINGS

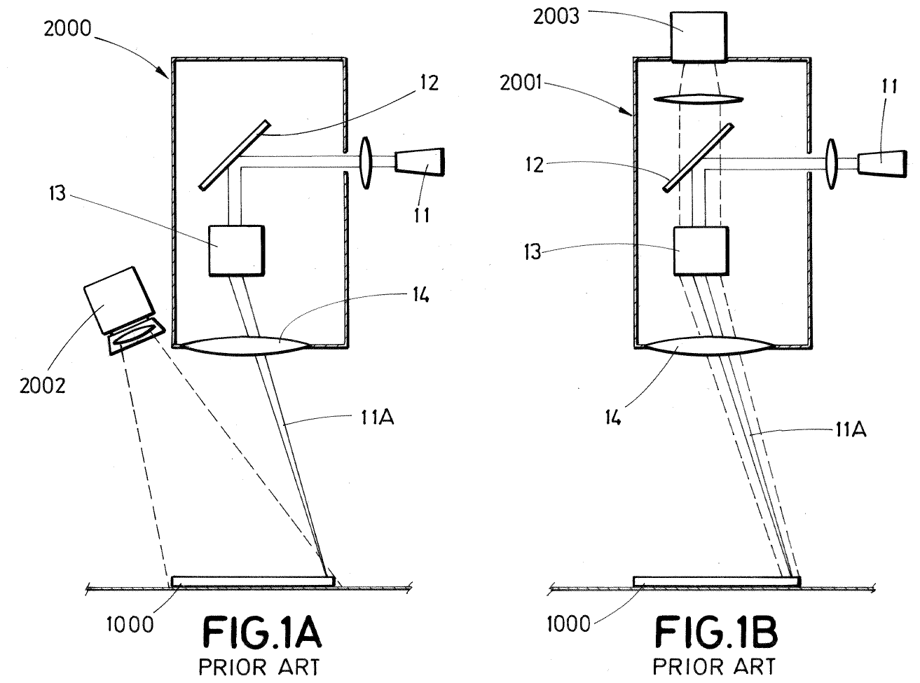

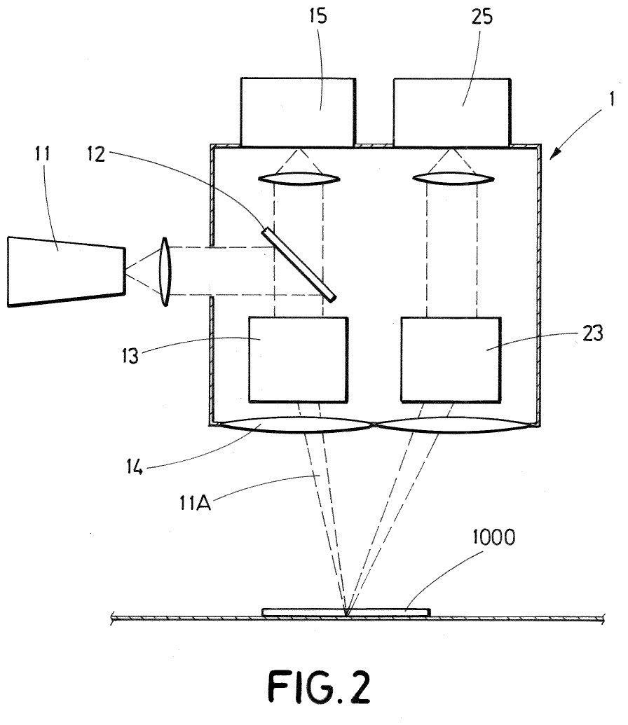

FIG. 2 schematically illustrates a laser processing head 1 in accordance with one possible embodiment of the disclosure. The laser processing head includes a beam splitter 12, a first scanner 13 and an F-theta lens 14, for example, as those of the prior art laser processing head described in relation to FIG. 1B. These components are used to direct a laser beam 11A from a laser source 11 onto an object 1000, for processing of the object, for example, for welding, cladding, additive manufacturing, laser hardening, laser softening, etc. Similarly to what has been discussed in relation to FIG. 1B, a first camera 15, such as a thermal camera, is provided for capturing images of a portion of the object via the first scanner 13. Due to this co-axial arrangement, the first camera 15 will capture images in correspondence with the point where the laser beam is projected onto the object, that is, images will be captured of the laser spot projected onto the surface and the immediately surrounding area. Thus, the first camera is suitably arranged for continuously capturing images of, for example, a melt pool produced by the laser beam when locally heating the object, or of the part of the melt pool that is currently being heated by the laser beam. As the laser spot is displaced along a track on the object (for example, by using the first scanner and/or other means, such as by displacing the entire processing head in relation to the object or vice-versa), the first camera will continue to receive images from the melt pool. The same is applicable to heated areas other than melt pools, for example, to an area being heated without melting in contexts such as laser hardening or laser softening.

In addition, a second camera 25 is provided, in this embodiment likewise associated to the laser processing head. The second camera 25 is associated to a second scanner, so that the second camera 25 can capture images of portions of the object 1000 via the second scanner 23. Thus, the way in which the second scanner 23 is operated determines the portions of the object of which, at each specific moment, an image can be captured by the second camera 25.

Thus, by means of this arrangement involving two cameras, images with high resolution can be obtained both of the heated area (such as a melt pool or part thereof) and of a portion behind the heated area and/or ahead of the heated area, that is, for example, a trailing portion where cooling and solidification are taking place. Also, images can be obtained repetitively with high frequency, that is, with a high frame rate. The second camera can thus be used to obtain information, such as in the form of pixelized thermal images, useful for determining factors such as cooling rate, which in turn can be useful for quality control. It can also be used for obtaining images of the area of the workpiece ahead of the laser spot, for example, in order to detect features of the workpiece such as openings, irregularities, etc., that may require adaptation of the path to be followed by the laser spot, and/or of the shape and/or energy distribution of the laser spot.

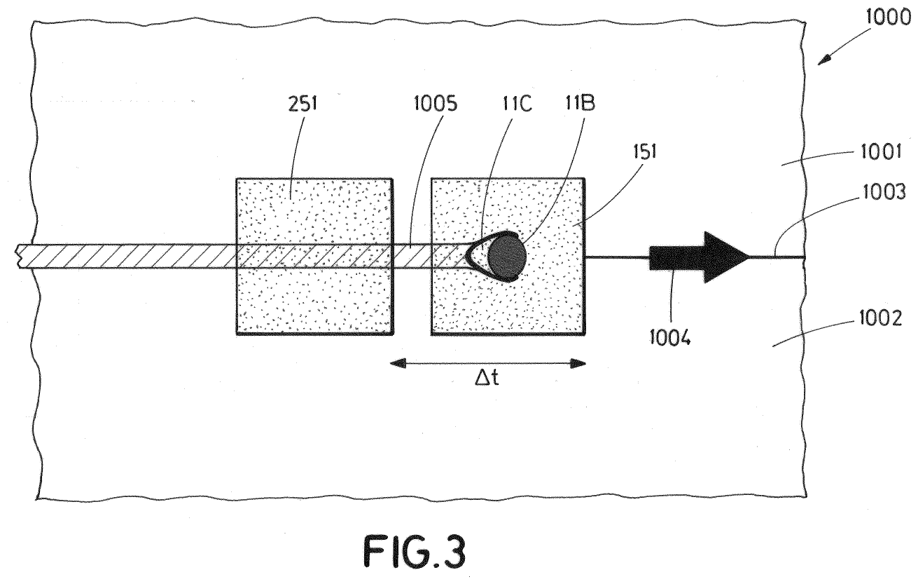

FIG. 3 is a top view showing an embodiment applied to laser welding of two workpieces 1001 and 1002 which, in this case, form the object 1000 subjected to laser processing. The workpieces, such as two metal objects, are arranged to mate along an interface area 1003, where the laser beam is applied to produce a weld seam 1005 while being displaced along a track 1004 aligned with the interface area 1003. The laser welding can be produced with a laser processing head 1 as shown in FIG. 2. In FIG. 3 it is schematically illustrated how the laser beam 11A produces a laser spot 11B in correspondence with the interface area 1003, so that a melt pool 11C is established, which travels with the laser spot 11B along the track 1004. In some embodiments, the laser spot is a primary laser spot obtained by the mere projection of the laser beam onto the interface area. In other embodiments, the laser spot is an effective spot obtained by relatively rapid repetitive scanning of the laser beam in two dimensions, following a scanning pattern. As explained above, this can facilitate a dynamic adaptation of the two-dimensional energy distribution while the effective spot is travelling along the track 1004.

The first camera is arranged to capture an image of a portion 151 of the object in correspondence with the laser spot 11B and including the melt pool 11C or part thereof. Thus, thermal information provided to the system by the first camera 15 can be used to determine parameters such as the maximum temperature of the melt pool 11C, the shape and/or size of the melt pool, the temperature distribution within the melt pool, the temperature of the part of the melt pool that is currently being heated by the laser beam, etc.

The second camera is arranged to capture images behind the melt pool, that is, in this case, in correspondence with the weld seam 1005 that is being formed by cooling and solidification in the area behind the melt pool, that is, in the area trailing behind the melt pool 11C. Thus, the second camera is arranged to capture images of a portion 251 trailing behind the melt pool. For example, in the illustrated embodiment the first and the second scanners are synchronized and operate with a delay Δt in what regards the movement along the track 1004 so that the respective cameras capture images of the same portion of the object but with a time difference Δt. Thus, and whereas the first camera captures images of the melt pool, the second camera captures images of a portion trailing behind the melt pool, so that the second camera can capture images of a portion suitable for determining parameters such as cooling rate.

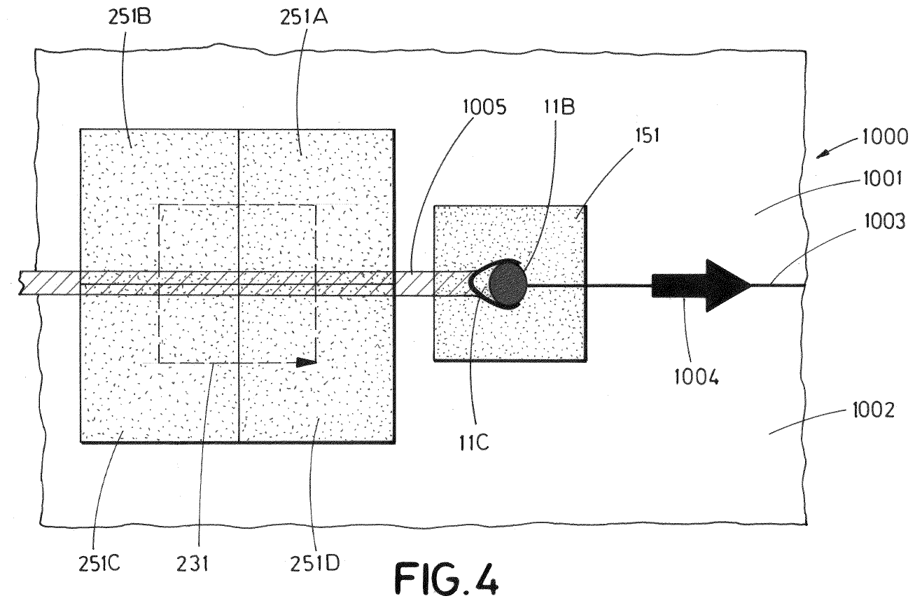

Sometimes it can be of interest to expand the area from which images are being captured by the second camera, for example, to obtain high-resolution images including points at substantial distances from each other, for example, along the track or at the sides of the track followed by the melt pool. This can sometimes be achieved by using a camera with higher resolution, and/or several cameras. However, in an alternative embodiment illustrated in FIG. 4, the second scanner is operated not only to make the second camera track the first camera with the delay mentioned above, but additionally to direct the second camera to different subareas trailing behind the melt pool, so as to obtain images corresponding to, for example, subareas arranged in rows and columns as in the 2×2 matrix formed by subareas 251A, 251B, 251C and 251D, as schematically illustrated in FIG. 4. This can be achieved by operating the second scanner 231 for two-dimensional scanning in accordance with a scanning pattern 231 schematically illustrated in FIG. 4, overlaid on the basic scanning movement that in some embodiments is used to make the second camera 25 track the first camera 15 along the track, as described above.

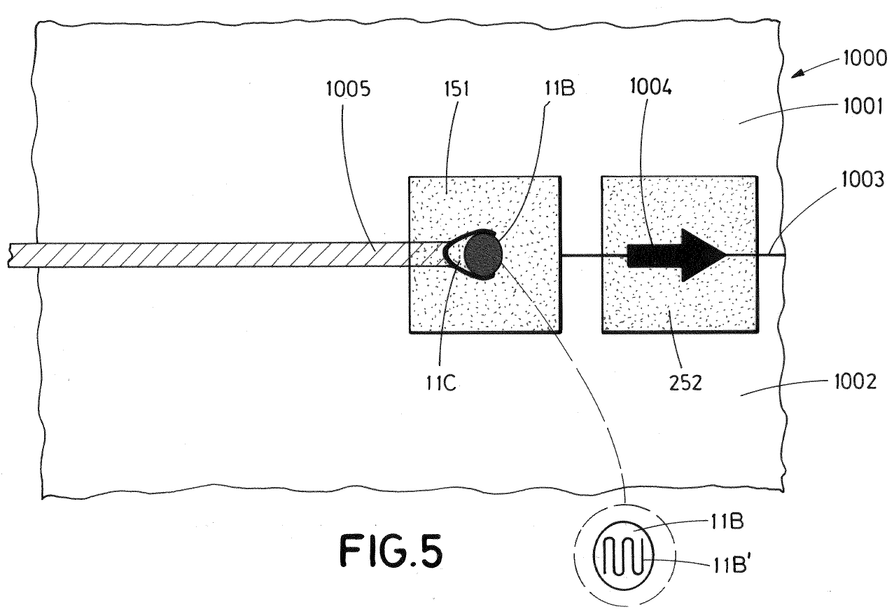

FIG. 5 illustrates an embodiment where instead of capturing images of a portion trailing behind the melt pool, the second camera is arranged to capture images of a portion 252 ahead of the melt pool. In other embodiments, images ahead of the melt pool can be obtained using the principles shown in FIG. 4. Capturing images ahead of the melt pool can be useful to, for example, detect irregularities in the interface area, defects in a previously established weld seam, or any other aspects that can be relevant for how the laser heating should be performed. In FIG. 5 it has additionally been schematically illustrated how the laser spot 11B is an effective spot established by rapid two-dimensional scanning of the laser beam along a scanning pattern 11B′ (schematically illustrated as a meander) which, together with features such as the velocity of the laser beam along the different portions of the scanning pattern and the power of the laser beam in correspondence with the different portions of the scanning pattern, determines the two-dimensional energy distribution within the effective spot 11B. Information provided by the second camera can be used to correctly adapt the two-dimensional energy distribution while the effective spot is advancing along the track 1004, taking into account aspects such as irregularities in the track, holes in the workpiece, etc. In this sense, the principles for dynamic adaptation of the two-dimensional energy distribution of an effective spot laid down in WO-2014/037281-A2 and WO-2015/135715-A1 can be used, and the information provided by one or both of the first and second cameras can be used to trigger the adaptation of the two-dimensional energy distribution. In some embodiments, the first scanner can carry out the scanning of the laser beam in accordance with the scanning pattern 11B′, and also the scanning of the effective spot 11B along the track 1004.

In this text, the term “comprises” and its derivations (such as “comprising”, etc.) should not be understood in an excluding sense, that is, these terms should not be interpreted as excluding the possibility that what is described and defined may include further elements, steps, etc.

The disclosure is obviously not limited to the specific embodiment(s) described herein, but also encompasses any variations that may be considered by any person skilled in the art (for example, as regards the choice of materials, dimensions, components, configuration, etc.), within the general scope of the disclosure as defined in the claims.

1. A method of processing an object with a light beam, the method including the following steps:
projecting a light beam onto an object using a first scanner for processing the object, said light beam projecting a light spot on the object for producing a heated area by locally heating the object;
displacing the heated area along a track on the object;
capturing images of a first portion of the object with a first camera, using the first scanner; and
capturing images of a second portion of the object with a second camera, using a second scanner;
wherein the method further includes the step of operating the first scanner and the second scanner so that the first camera captures images of the heated area, whereas the second camera captures images of portions of the object trailing behind the heated area and/or ahead of the heated area.

2. The method according to claim 1, further including the step of repetitively scanning the light beam in two dimensions with the first scanner so that the light beam follows a two-dimensional scanning pattern and establishes an effective spot having a two-dimensional energy distribution determined by at least the scanning pattern followed by the light beam, a scanning speed and a light beam power, and wherein the two-dimensional energy distribution is dynamically adapted while the heated area is displaced along the track.

3. The method according to claim 1, wherein the first scanner is used to displace the heated area along the track and wherein the first scanner and the second scanner are operated in synchronization so that the second camera captures images of the object having a pre-determined spatial and/or temporal relation to the heated area.

4. The method according to claim 1, further comprising the step of repetitively scanning in two dimensions with the second scanner and operating the second camera in synchronization with the second scanner so as to repetitively obtain a sequence of images of different subareas of the object behind and/or ahead of the heated area.

5. The method according to claim 4, wherein the different subareas are arranged adjacent to each other.

6. The method according to claim 5, wherein the different subareas are arranged in rows and columns forming a matrix.

7. The method according to claim 1, wherein the second camera captures images of portions of the object trailing behind the heated area.

8. The method according to claim 7, wherein images of portions from the second camera are used for determining a cooling rate.

9. The method according to claim 1, wherein the cameras are infrared cameras.

10. The method according to claim 1, wherein both the first scanner and the second scanner are arranged in a processing head.

11. The method according to claim 1, for additive manufacturing.

12. The method according to claim 1, for joining at least two workpieces by welding them together.

13. The method according to claim 1, for laser cladding or laser hardening.

14. The method according to claim 1, wherein the light beam is a laser beam.

15. A processing system comprising: a processing head for projecting a light beam onto an object for processing the object, the processing head including a first scanner for controlled displacement of the light beam in relation to the object;
a first camera associated to the first scanner for capturing images of a portion of the object via the first scanner; and
a second camera and a second scanner, the second camera being associated to the second scanner for capturing images of a portion of the object via the second scanner,
the system being programmed for operating the first scanner and the second scanner so that during processing of the object with the light beam the first camera captures images of a heated area produced by the light beam, whereas the second camera captures images of portions ahead of the heated area and/or trailing behind the heated area.

16. The processing system according to claim 13, wherein the processing head includes the first scanner, the second scanner, the first camera and the second camera.

17. The processing system according to claim 15, programmed for operating.
